(19) United States
(12) Patent Application Publication
(10) Pub. No.: US 2007/0274805 A1
(43) Pub. Date: Nov. 29, 2007

(54) Fastener and assembly therewith

(76) Inventors: David R. Nebl, Prospect Heights, IL (US); Stephen R. Dohm, Geneva, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/711,362

(22) Filed: Feb. 27, 2007

Related U.S. Application Data
(60) Provisional application No. 60/808,631, filed on May 26, 2006.

(51) Int. Cl. F16B 39/00; F16B 43/00

(52) U.S. Cl. 411/307; 411/371.1

(57) ABSTRACT

A threaded fastener assembly includes a male threaded component having a thread and a thread advancement stop as a compression limiter for engagement of the thread in a female threaded component. A conical spring washer establishes pre-load of an assembled joint in a variable clamp design. Prevailing torque is established by a wave thread portion of the male thread in the female threaded component.

### CROSS-REFERENCE TO RELATED APPLICATIONS

The present regular United States Patent Application claims the benefits of U.S. Provisional Application Ser. No. 60/808,631 filed on May 26, 2006.

### FIELD OF THE INVENTION

The present invention relates generally to fasteners, such as screws and bolts and, more particularly, to fastener assemblies comprising a screw or bolt, a washer and a female threaded fastener for securing together items of different materials in a joint subject to expansion and contraction.

### BACKGROUND OF THE INVENTION

It is known to provide a standard screw or bolt and washer assembly adapted to thread into a U-nut clip to secure components together, such as securing a metal component and a plastic component. One such known application concerns bumper assemblies in automobiles such as, for example, SUV's and trucks. While such assemblies have worked well, they are not without deficiencies.

It has been observed that when assemblies such as those described above are fastened tightly to provide full clamp load, the less resilient material, such as plastic fastened to a metal bumper, can buckle or bend when subjected to varying environmental conditions, such as hot and cold conditions. If the fastener assembly is tightened to full clamping load at low temperatures, for example, expansion at high temperatures can result in unsightly buckling. Conversely, if the fastener assembly is tightened to provide full clamp load when expansion has occurred at high temperatures, the assembly can become loose at colder temperatures and may become disengaged from vibration during use. Further, it is difficult to predict the conditions under which a vehicle will be operated. For example, one vehicle may be operated in an extremely warm climate where expansion is experienced, while another vehicle may be operated in a very cold climate where expansion is not experienced. Further, the same vehicle can readily travel from one extreme environment to the opposite environmental extreme. Accordingly, it is impractical to provide different clamp load tightening for different vehicles when the vehicles are assembled.

### SUMMARY OF THE INVENTION

The present invention provides a fastener assembly including a male threaded member associated with a female threaded member, with an interactive thread on a part thereof to provide prevailing torque for inhibiting unintended back out, a thread advancement stop to provide clamp load relative to the female threaded member and a spring washer to provide clamping force against objects held by the fastener assembly.

In one aspect thereof, the present invention provides a threaded fastener with a shaft having a helical thread thereon, a thread advancement stop associated with the thread, a head on the shaft and a compression member axially restrained on the shaft between the head and the thread advancement stop.

In another aspect thereof, the present invention provides a threaded fastener with a shaft and a helical thread on the shaft. The thread has a thread portion of non-straight line helical form. A thread advancement stop is provided on the shaft at an end of the thread and a head on the shaft is spaced from the thread advancement stop. A compression member is constrained in axial movement on the shaft between the thread and the head.

In a still further aspect thereof, the present invention provides a fastener assembly for securing relative positions between a first object and a second object, each object having a hole therethrough. The fastener assembly includes a male fastener component having a shaft, a thread on the shaft and a head at one end of the shaft. The shaft extends through the first object and the second object, with the head on one side of one of the first and second objects, and the shaft extending through an opposite side of the other of the first and second objects. A female threaded component engages the thread on the shaft on the opposite side of the other object. The shaft includes a thread advancement stop extending outwardly radially of the thread between the thread and the head. The thread advancement stop engages the female threaded component. A spring component between the head and the first side of the first object provides clamp load against the first object.

An advantage of the present invention is providing a fastener for securing objects that may expand or contract during use.

Another advantage of the present invention is providing a threaded fastener suitable for holding plastic components in automobile assemblies.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an elevational view of a fastener in accordance with the present invention;

FIG. 2 is a cross-sectional view of a fastener assembly including the fastener shown in FIG. 1; and

FIG. 3 is an elevational view similar to that of FIG. 1, but illustrating a second embodiment of a fastener in accordance with the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

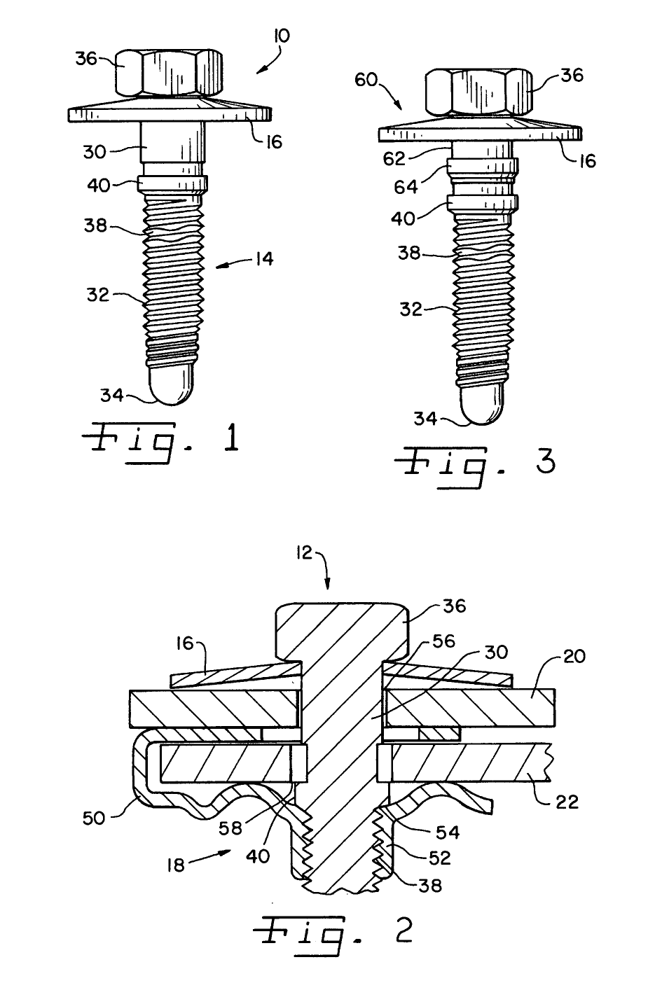

Referring now more specifically to the drawings and to FIG. 1 in particular, a fastener 10 in accordance with the present invention is shown for use in a fastener assembly 12 (FIG. 2). Fastener 10 includes a male fastener component 14 and a spring component 16 associated with a female fastener component 18 as part of fastener assembly 12. As illustrated in FIG. 2, fastener assembly 12 secures a first object 20 and a second object 22 relative to one another.

Male fastener component 14 includes a shaft 30 having a thread 32 thereon. In the exemplary embodiment, shaft 30 includes a rounded distal end 34, but may be of other shapes including blunt or tapered as desirable for a particular application and use of the present invention. A head 36 is provided at an opposite end of shaft 30 from distal end 34. In the exemplary embodiment, head 36 is configured as a hex-shaped body for engagement by a wrench or other implement or tool for tightening fastener 10. However, it should be understood that other configurations and forms of head 36 can be used. For example, head 36 can be configured for engagement with and by other types of driving implements, including screwdrivers and other drive implements inserted into a properly configured opening in head 36.

Thread 32 can be a common screw thread configuration throughout a substantial portion of the length thereof and can be of single or multiple thread design. While shown as a right hand thread, it should be understood that a left hand thread also can be used. In a common thread configuration, for a given or basic thread pitch, the male thread is provided at equal to or less than the basic pitch, and the female thread is provided at equal to or more than the basic pitch. The result is that the male thread “floats” within the female thread, allowing the two components to be run together with minimal interference or resistance until clamping pressure is applied during final tightening of the fastener.

A thread portion 38 of thread 32 is of modified configuration. In contrast to standard threads that are known to follow a straight-line helical path within the helical pattern, thread portion 38 follows a curved-line path within a generally helical pattern. Within thread portion 38, the standard straight-line helical path deviates into a wave-like pattern, with portions above and/or below the standard straight-line path. Accordingly, thread portion 38 provides a prevailing torque within female component 18 when engaged therewith. The location of thread portion 38 relative to the length of thread 32 is selected so as to position thread portion 38 within female component 18 when fastener 10 is in its tightened down condition to be described. The prevailing torque supplied by wave thread portion 38 inhibits back out of fastener 10 from female component 18 independent of any clamp load established by fastener assembly 12 on objects 20, 22.

A thread advancement stop 40 is provided at the end of thread 32 nearest head 36. Thread advancement stop 40 is of greater diameter than thread 32 and is configured so as not to enter the threads of female threaded component 18. In the exemplary embodiment, thread advancement stop 40 is a continuous annular flange or ring about shaft 30; however, it should be understood that discontinuous bodies also can be used. Further, the positioning of thread advancement stop 40 relative to thread 32 can be immediately adjacent as shown or can be at some spaced distance, again depending on the relationship between thread 32 and the shape and configuration of female threaded component 18. Thread advancement stop 40 is provided so as to abut against female component 18 in a manner whereby further advancement of thread 32 relative to female component 18 is prevented. Thread advancement stop 40 limits the compression that can be applied against articles held by fastener assembly 12 by limiting the axial advancement of male fastener component 14 relative to female fastener component 18.

In the exemplary embodiment, spring component 16 is a conical washer having a generally concave shape facing toward first object 20. Spring component 16 applies spring force between head 36 abutting one surface thereof near the center thereof and first object 20 engaging the peripheral edge thereof on the side of spring component 16 opposite from head 36.

In the exemplary embodiment, female component 18 includes a clip 50 engaging second object 22 and a female threaded portion 52 as an integral part of clip 50. While shown as a monolithic body, female threaded portion 52 and clip 50 also can be individual parts secured to one another. An entrance surface 54 is provided at the entrance end of female threaded portion 52. It should be understood that clip 50 is illustrated as a suitable and advantageous structure for pre-installing female threaded portion 52 relative to second object 22. However, the present invention can be used with other types of female components including standard nuts, threaded plates or other threaded components and devices into which fastener 10 is installed as part of an assembly, such as exemplary assembly 12.

FIG. 2 illustrates the manner of installation and use of fastener 10.

Fastener 10 extends through aligned holes 56 and 58 in first and second objects 20 and 22, respectively, with head 36 on one side of first object 20 and distal end 34 of shaft 30 extending through an opposite side of second object 22. Thread 32 is advanced into female threaded portion 52 until thread advancement stop 40 abuts entrance surface 54. Fastener 10 can advance no further into female component 18 with thread advancement stop 40 engaged against entrance surface 54. Wave thread portion 38 is received in female threaded portion 52 and provides prevailing torque inhibiting back out of fastener 10 from female component 18. A fixed distance is established between thread advancement stop 40 and head 36. Within that fixed distance, first object 20, second object 22 and spring component 16 are arranged. The compressive force of first object 20 against clip 50 and/or second object 22 is established and maintained by spring component 16. Even as one or the other of first object 20 or second object 22 expands or contracts due to environmental changes, the compressive force in the fastened joint is controlled by spring component 16. Accordingly, various types of spring components 16, such as conical washers of differing spring strength can be used to establish different clamp loads between first and second objects 20, 22 that will be maintained even as objects 20 and 22 expand or contract.

FIG. 3 illustrates another embodiment of the present invention in which a fastener 60 includes a shaft 62 having a thread 32 with a wave thread portion 38, a head 36 and a thread advancement stop 40, all as described previously with respect to fastener 10. Fastener 60 further includes a spring component retainer flange 64 provided between thread advancement stop 40 and head 36. Retainer flange 64 in the exemplary embodiment is a continuous ring and provides a stop for axial movement of spring component 16 along shaft 30, thereby retaining spring component 16 spaced from thread advancement stop 40. Retainer flange 64 can be a continuous flange from shaft 62 as shown, or can be a plurality of discrete, spaced protuberances from shaft 62.

Those skilled in the art will understand readily that fasteners 10 and 60 of the present invention can be formed by standard, well-known thread forming techniques. For example, a formed headed blank of shaft 30 can be fitted with spring component 16 such as conical washer 16. Thread rolling techniques that expand thread 32, form wave portion 38 and establish thread advancement stop 40 of larger diameter than the opening in conical washer 16 can then be performed. Retainer flange 64, if provided, can be formed at the same time. Conical washer 16 is thereby provided in a preinstalled, non-removable condition on male component 14 and cannot be disassociate therefrom.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A threaded fastener comprising:
a shaft having a helical thread thereon;
a thread advancement stop associated with said thread;
a head on said shaft; and
a compression member axially restrained on said shaft between said head and said thread advancement stop.

2. The threaded fastener of claim 1, said thread advancement stop being a continuous flange surrounding said shaft.

3. The threaded fastener of claim 1, said compression member being a conical washer.

4. The threaded fastener of claim 3, said thread advancement stop being a flange surrounding said shaft.

5. The threaded fastener of claim 4, including a second flange on said shaft between said head and said thread advancement stop restraining said washer in spaced relation to said thread advancement stop.

6. The threaded fastener of claim 1, including a second flange on said shaft between said head and said thread advancement stop restraining said compression member in spaced relation to said thread advancement stop.

7. The threaded fastener of claim 1, including a wavy thread portion on said helical thread.

8. The threaded fastener of claim 7, said thread advancement stop being a flange surrounding said shaft.

9. The threaded fastener of claim 7, said compression member being a conical washer.

10. The threaded fastener of claim 9, said thread advancement stop being a flange surrounding said shaft.

11. The threaded fastener of claim 10, including a second flange on said shaft between said head and said thread advancement stop restraining said conical washer in spaced relation to said thread advancement stop.

12. A threaded fastener comprising:
a shaft;
a helical thread on said shaft;
said thread having a thread portion of non-straight line helical form;
a thread advancement stop on said shaft at an end of said thread;
a head on said shaft spaced from said thread advancement stop; and
a compression member constrained in axial movement on said shaft between said thread and said head.

13. The threaded fastener of claim 12, said thread advancement stop being a continuous flange surrounding said shaft.

14. The threaded fastener of claim 12, said compression member being a conical washer.

15. The threaded fastener of claim 14, including a flange on said shaft between said head and said thread advancement stop; and said conical washer being constrained in axial movement along said shaft between said head and said flange.

16. The threaded fastener of claim 14, said thread advancement stop being a continuous annular flange.

17. A fastener assembly for securing relative positions between a first object and a second object, each having holes therethrough, said fastener assembly including:
a male fastener component having a shaft, a thread on said shaft and a head at one end of said shaft, said shaft extending through said first object and said second object, with said head on one side of one of said first and second objects, and said shaft extending through an opposite side of the other of said first and second objects;
a female threaded component engaging said thread on said shaft, said female threaded component provided on said opposite side of said other object;
said shaft including a thread advancement stop extending outwardly radially of said thread between said thread and said head, said thread advancement stop engaged against said female threaded component; and
a spring component between said head and said first side of said first object, said spring component providing clamp load against said first object.

18. The fastener assembly of claim 17, said thread including a wave threaded portion engaged in said female threaded component.

19. The fastener assembly of claim 17, including a clip engaging said second object and secured to said female threaded component.

20. The fastener assembly of claim 17, including a continuous annular flange on said shaft between said head and said thread advancement stop, and said spring component restrained by said flange in spaced relation to said thread advancement stop.
